(19) United States
(12) Patent Application Publication
(10) Pub. No.: US 2018/0293189 A1
(43) Pub. Date: Oct. 11, 2018

(54) MEMORY MANAGER FOR AUTONOMOUS MEMORY DEVICE

(71) Applicant: HEWLETT PACKARD ENTERPRISE DEVELOPMENT LP, Houston, TX (US)

(72) Inventors: Reza M BACCHUS, Spring, TX (US); Melvin K BENEDICT, Magnolia, TX (US); Eric L POPE, Tomball, TX (US)

(21) Appl. No.: 15/766,367

(22) PCT Filed: Oct. 13, 2015
(86) PCT No.: PCT/US2015/055320

§ 371 Date: Apr. 6, 2018

(51) Int. Cl. G06F 13/16; G06F 12/02; G06F 9/30

(52) U.S. Cl. CPC G06F 13/1673; G06F 9/30196; G06F 12/0215

(57) ABSTRACT

A memory device includes a memory storage media to store data for the memory device. A memory manager initiates an autonomous precharge of a buffered page into the memory storage media in the absence of detecting a command at an input of the memory device for a period of time that exceeds a threshold.

### BACKGROUND

Synchronous dynamic random access memory (SDRAM) is widely used in computers from embedded and mobile applications to servers and supercomputers. In some examples, SDRAM is attached to a memory controller via a Double Data Rate (DDR) physical bus such as DDR3 or DDR4. Memory controllers for DDR busses allow data to be transferred on both rising and falling edges of the system's memory clock. Thus, DDR memory controllers are more complicated when compared to single data rate controllers however they allow for twice the data to be transferred without increasing the memory cell's clock rate or bus width. The SDRAM protocol and the DDR bus are tightly coupled to optimize memory latency and throughput. To facilitate this, the synchronous DRAM protocol is deterministic; that is, response times for specific commands are initialized after power-up and do not change during runtime.

### BRIEF DESCRIPTION OF THE DRAWINGS

FIG. 1 illustrates an example of a memory device that operates autonomously from external memory controller commands to activate and/or precharge pages of memory in the device.

FIG. 2 illustrates an example of system that employs a memory device that operates autonomously from a memory controller to activate and/or precharge pages of memory in the device.

FIG. 3 illustrates an example of a method to provide autonomous operations from external memory controller commands to activate and/or precharge pages of memory in the device.

FIG. 4 illustrates an example of a method to provide autonomous memory device operations from an external memory controller.

FIG. 5 illustrates an example of another method to provide autonomous memory device operations from an external memory controller.

### DETAILED DESCRIPTION

This disclosure relates to a memory device that employs a memory manager to enable memory operations autonomously from an external memory controller. Such memory operations can include autonomous management of memory paging operations, such as activating a memory page from stored memory into a buffer and precharging an active page from the buffer back into memory without receiving an explicit command at its input from an external memory controller.

For example, after a memory page has been activated, the memory manager in the memory device tracks an amount of time since last access (e.g., read or write access) occurred with an external device such as the memory controller. When the time since last access reaches a predetermined threshold (e.g., counter value exceeded), the memory manager automatically (and autonomously from the memory controller commands) performs a precharge operation which stores an actively buffered page back into memory. Such autonomous precharge operation enables the memory device and its associated memory storage media to enter into a low power state, thereby helping to conserve electrical power.

Although the memory manager enables autonomous operations, the memory manager can also respond to explicit page and precharge commands from the external memory controller. For instance, if a requested page to be read from or written to memory is not presently active in the memory device buffer, the memory manager can initiate a precharge of the current active page and subsequently activate the requested page. When the requested page has been activated, the memory manager can provide an output command to the controller to signal that the current memory page request has been completed and transfer data as required.

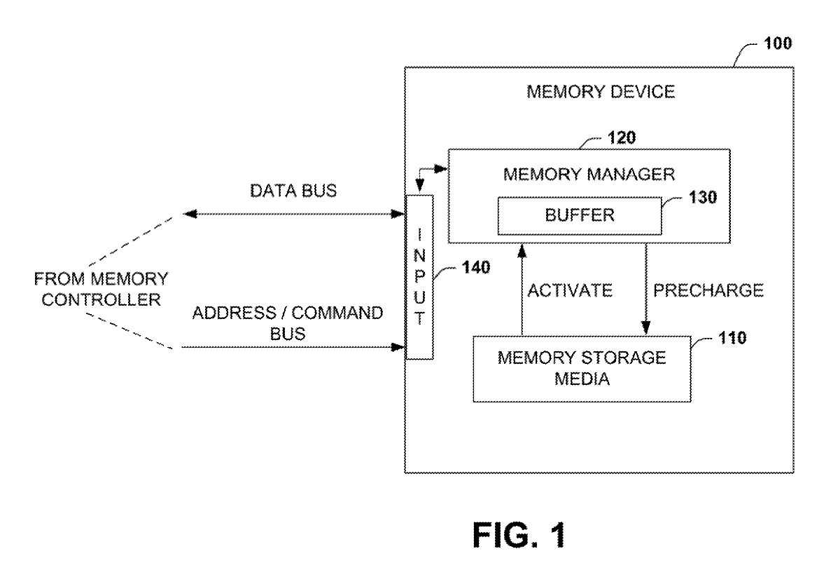

FIG. 1 illustrates an example of a memory device 100 to operate autonomously from external memory controller commands. The memory device 100 includes a physical memory storage media 110 to store data for the memory device. The memory storage media 110 can include substantially any type of media for memory storage. By way of example, the memory storage media 110 can include a dynamic random access memory, a resistive random access memory, a phase change memory, or a spin transfer torque memory.

The memory device 100 also includes a memory manager 120 that controls autonomous operations of the memory device 100. For example, the memory device 100 autonomously activates and/or precharges one or more pages of memory in the device. As used herein, the term autonomous refers to operations of the memory device 100 and/or memory manager 120 that operate independently of any explicit command issued from one or more external memory controllers that communicates with the memory device. The autonomous operations thus are separate and independent from the memory protocol implemented via an address and command bus. The memory manager 120 can also execute operations in response to explicit commands from one or more memory controllers.

By way of example, the memory manager 120 initiates an autonomous precharge of a buffered page from a buffer 130 into the memory storage media 110 in the absence of detecting a command at an input of the memory device for a period of time that exceeds a threshold. The memory manager 120 also autonomously initiates an activate operation to transfer a page of data from the memory storage media 110 into the buffer 130. The memory manager 120 also handles housekeeping functions associated with each of the autonomous paging operations described herein. For example, the buffer 130 is a row buffer for a bank of memory corresponding to the storage media 110.

As used herein, the term precharge indicates an operation through which a page of memory is transferred from the buffer 130 to the storage media 110. Following a precharge, the memory manager 120 operates in a lower power state since operation with the buffer 130 can be stopped and memory manager 120 operations reduced while data has been stored in the memory storage media 110.

The memory manager 120 can be implemented as a state machine, gate array, processor, and/or other circuitry to manage the autonomous activating and precharging of memory pages from/to the memory storage media 110 as described herein. In some examples, the memory manager 120 can autonomously decide to activate or precharge data from/to the buffer 130.

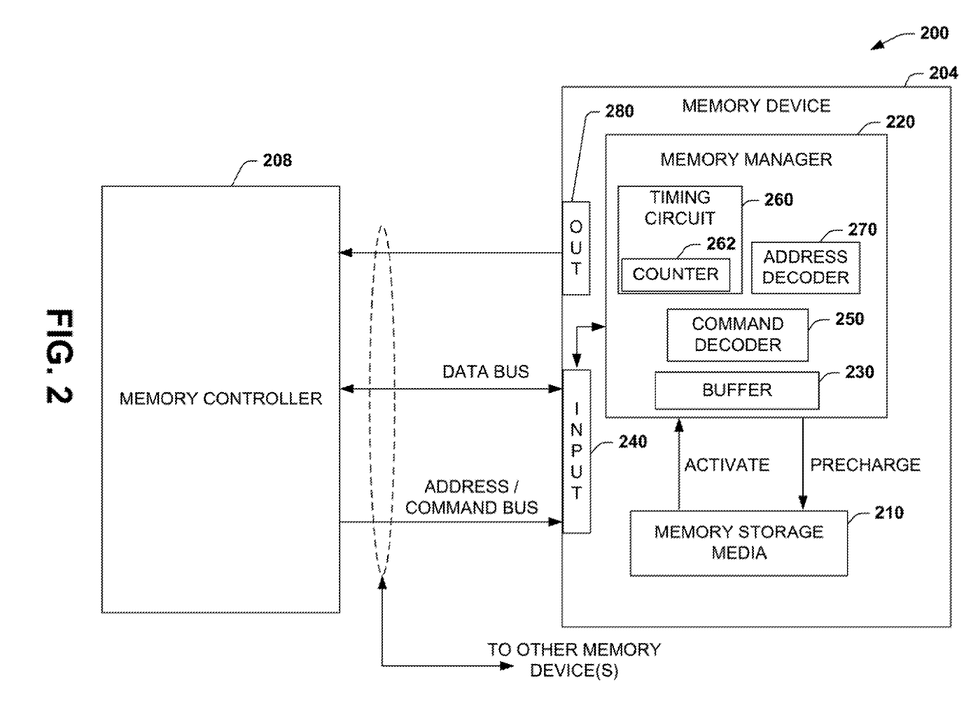

By way of example, the memory manager 120 can initiate an autonomous precharge operation if an internal timer (See e.g., FIG. 2) has timed out, allowing the memory manager 120 to store contents from the buffer 130 into corresponding location of the memory storage media 110. In response, the memory device can enter a low power state (e.g., memory manager and buffer activity reduced). Autonomous precharge can also occur if the memory manager detects a request for a different page than what is currently activated in the buffer 130. Memory manager 120 can initiate an autonomous activate operation if no active page is currently open in the buffer 130. Autonomous activate can also occur if a different page has been requested than what is currently active in the buffer 130, where an autonomous precharge is first executed by the memory manager 120 followed by an autonomous activate to retrieve the different page.

In other examples, the memory manager 120 can activate or precharge data to/from the buffer 130 in response to explicit commands received at input 140 (or inputs) of the memory device 100 from an external memory controller (or other external device such as a processor). External commands can include explicit read or write commands via a data bus at the input 140. Commands such as activate and precharge can also be received via an address/command bus at the input 140. The actions the memory manager implements in response to explicit commands depends on the state of the memory manager, including whether or not data is currently loaded in the buffer 130 and whether or not the buffered data can fulfill the command.

The following examples assume that the memory manager and buffer are in a state that can fulfill explicit command without performing autonomous, intervening operations (e.g., like activate and/or precharge). If an explicit read command is received at its input via its external command bus, the memory manager 120 transfers the contents of the buffer 130 to the data bus. Similarly, if an explicit write command is received at its input, the memory manager 120 loads the buffer 130 from the data bus. If an explicit precharge command is issued, the memory manager 120 transfers contents of the buffer 130 to the memory storage media 110. If an explicit activate command is issued, the memory manager loads the requested page from the memory storage media 110 into the buffer.

The memory manager 120 can also include an output to generate a response to the command that a page of memory has been stored, activated, or precharged. For example, if an external memory controller assumes that a page is open that has been autonomously precharged by the memory manager 120, the memory manager can delay issuance of the response to the command to provide time to activate the precharged page. For pages that have been autonomously precharged or in response to other periodic controls, the memory manager 120 can also issue a refresh command to the memory storage media 110 to refresh selected areas of memory.

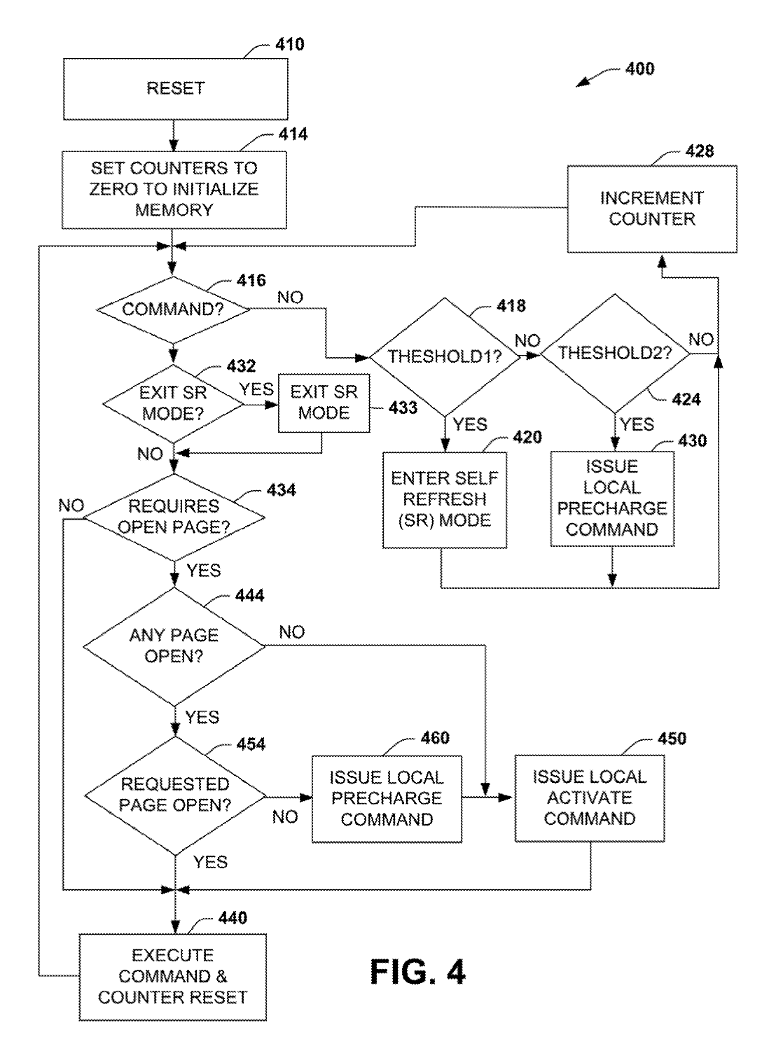

FIG. 2 illustrates an example of system 200 that employs a memory device 204 that operates autonomously from a memory controller 208 to activate and precharge pages of memory in the device. The memory device 204 includes a memory storage media 210 to store data for the memory device. A memory manager 220 initiates an autonomous precharge of a buffered page from a buffer 230 into the memory storage media 210 in the absence of detecting a command at an input 240 of the memory device 204 for a period of time that exceeds a threshold. Also, as will be illustrated and described below with respect to the method of FIG. 4, the memory manager can also include other autonomous operations. For example, if a requested page from the external memory controller 208 is not presently open in the buffer, the memory manager 220 can autonomously precharge the current page (e.g., the non-requested page) from the buffer 230 into the memory storage media and subsequently activate the requested page from the memory controller into the buffer. As shown in the example of FIG. 2, the memory controller 208 can communicate with one or more other memory devices 204, where each of the memory devices can include respective memory storage media, memory managers, and other circuitry to perform the autonomous paging operations, such as precharge and activation described herein. Such memory devices can be placed on a common substrate such as dual-inline memory module (DIMM), where each member of the DIMM can communicate with the controller 208 (and/or other controllers not shown).

As noted previously, the memory manager 220 can be implemented as a state machine, gate array, processor, and/or other logic circuit to manage the autonomous activating and precharging of memory pages from/to the memory storage media 210 as described herein. In some examples, the memory manager 220 can autonomously decide to activate or precharge data from/to the buffer 230 based on detecting that a timing threshold has been exceeded or if a different page is requested than what is presently active in the buffer 230. In other examples, the memory manager 220 can activate or precharge data to/from the buffer 230 in response to explicit commands received at inputs 240 of the memory device 204 from the memory controller 208 (or other external device such as a processor). Commands can include explicit read or write commands via a data bus at the inputs 240. Commands such as activate and precharge can also be received via an address/command bus at the inputs 240.

The memory controller 208 generates a command provided to the input 240 of the memory device 204. The memory manager 220 can include a command decoder 250 to process each command received at the input 240 of the memory device 204. The command decoder 250 notifies the memory manager 220 whether to explicitly activate the page of memory into the buffer 230 from the memory storage media 210, to explicitly precharge the buffered page into the memory storage media 210 from the buffer, or to deactivate the autonomous precharge of the buffered page based on decoding of the command.

The memory manager 220 can also include a timing circuit 260 to increment a counter 262 (e.g., via a clock) to measure the period of time from when the last command was received at the inputs 240 from the memory controller. The command can be an explicit precharge command, a read command or a write command to one or more blocks of data, for example. Thus, if the counter exceeds a predetermined threshold before the next command is detected by the decoder 250 at the input 240 of the memory device 204, the memory manager 220 initiates the autonomous precharge of the buffered page from the buffer 230 into the memory storage media 210.

In another example of autonomous paging operations, the memory manager 220 can execute an autonomous precharge of the buffered page from the buffer 230 into the memory storage media 210 if the external memory controller 208 issues a request (e.g., an explicit read, write or precharge command) for a different page (e.g., having a different memory address) from the memory storage media than the currently buffered page. After the autonomous precharge has been executed in response to the different page being requested, the memory manager 220 then executes an autonomous activate command to activate the requested page from the memory storage media 210 into the buffer 230 based on the data identified in the command from the external memory controller 208.

As shown, memory manager 220 can also include an address decoder 270 to determine where to store and retrieve data from the memory storage media 210 based on requests from the memory controller 208. The address decoder 270 provides the address of the currently requested page from the memory controller 208 that is retrieved in the buffer 230. If the command is for a request for a different page from the current page in the buffer, the address decoder 270 notifies the memory manager 220 of the requested page. In response to determining that the requested page is different from the buffered page (e.g., in response to comparing memory addresses for the buffered page and the requested page), the memory manager autonomously precharges the current buffer contents to the designated address in the storage media 210 and autonomously activates the next page into buffer based on the different page request.

The memory manager 220 can also execute an autonomous activate command. For example, if the memory controller 208 issues an explicit command requesting data from a page of the memory storage media 210 that has previously been precharged (e.g., via an autonomous precharge command), the memory manager can implement autonomous page management to enable the memory device to respond to the request. The autonomous page management can include the activate operation to buffer the page of data identified in the explicit command. If another page is currently buffered, the memory manager can first execute an autonomous precharge and then implement the autonomous activate operation.

The memory manager 220 can also include an output 280 to generate a response to the command from the memory controller 208 that a page of memory has been stored, activated, or precharged. For pages that have been autonomously precharged, the memory manager 220 can execute an autonomous refresh command to the memory storage media 210 to refresh areas of memory that have been autonomously precharged. The autonomous refresh command operates independently of refreshes that may or may not be issued by the memory controller 208 to the memory device 204. As will be illustrated and described below with respect to the method of FIG. 4, a second timing threshold can be set-up via the timing circuit 260 (e.g., monitor counter 262 for second threshold) to trigger the refresh operation. The refresh can include reading a segment of dynamic RAM and rewriting the segment back to memory to refresh the memory. In some cases, local refreshes can be preformed for pages that have been autonomously precharged. In other examples, memory-wide refreshes can be performed autonomously intermittently or periodically by the memory manager 220.

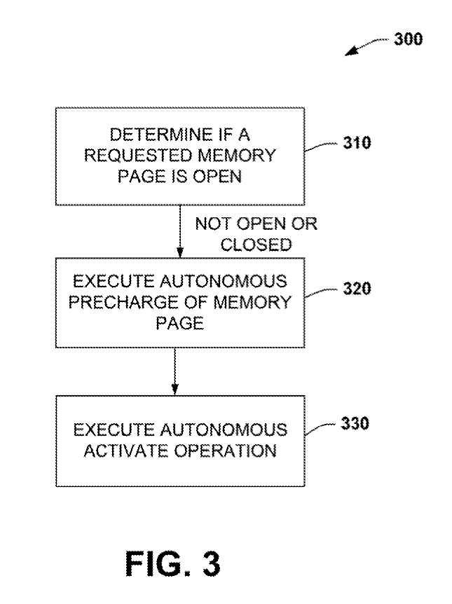

In view of the foregoing structural and functional features described above, example methods will be better appreciated with reference to FIGS. 3 and 4. While, for purposes of simplicity of explanation, the methods are shown and described as executing serially, it is to be understood and appreciated that the methods are not limited by the illustrated order, as parts of the methods could occur in different orders and/or concurrently from that shown and described herein. Such methods can be executed by various components and executed by an integrated circuit, computer, or a processor, for example.

FIG. 3 illustrates an example of a method 300 to provide autonomous operations from external memory controller commands to activate and precharge pages of memory in the device. At 310, the method includes determining if a requested memory page from a memory storage media is open (e.g., via memory manager 120 of FIG. 1). At 320, the method 300 includes initiating an autonomous precharge of another memory page into the memory storage media if the requested memory page from the memory storage media is not open(e.g., via memory manager 120 of FIG. 1). At 330, the method 300 includes activating the requested memory page into a buffer via an autonomous activate command from the memory storage media if the requested memory page is not activated in the buffer. The method 300 can also include initiating an autonomous precharge of a buffered page into the memory storage media in the absence of detecting a command at an input of a memory device for a period of time that exceeds a threshold. The method 300 can also include issuing a refresh command to the memory storage media to refresh areas of memory that have been autonomously precharged.

As a further example, after a memory page has been activated, a memory manager (e.g., memory manager 120 or 220), which resides in the memory device and executes the method 300, tracks an amount of time since a last explicit command (e.g., read, write, explicit precharge) was received from an external device, such as the memory controller (e.g., memory controller 208). When the time since last command reaches a predetermined threshold (e.g., counter value of timing circuit 260 is exceeded), the method 300 automatically performs an autonomous precharge operation. Such autonomous memory operations executable by the method 300 can include autonomous management of memory paging operations, such as activating a memory page from stored memory into a buffer and precharging an active page from the buffer back into memory without receiving an explicit command at its input from an external memory controller. The autonomous operation can also include a refresh operation, such as disclosed herein. Such autonomous precharge via the method 300 allows the memory device and its associated memory storage media to be placed into a low power state thus conserving overall system power.

While the method 300 enables autonomous management of memory paging operations to be implemented within a memory device (e.g., device 100 or 204), the memory device implementing the method 300 can also respond to and execute explicit commands received at its inputs from the external memory controller. For instance, if a requested page to be read from or written to is not presently active in the memory device buffer, the memory manager implementing the method 300 can initiate a precharge of the current active page and subsequently activate the requested page. When the requested page has been activated, an output command can be provided at an output of the memory device to the controller to signal that activation of the current memory page request has been completed.

FIG. 4 illustrates an example of a method 400 to provide autonomous memory paging operations at a memory device (e.g., device 100 or 204). As disclosed herein, the autonomous paging operations are independent from commands received from an external memory controller. At 410, the method 400 includes starting up from a reset state (e.g., from a power up state). At 414, the method 400 includes setting counters to zero to initialize a memory device (e.g., device 100 or 102). The counter can be utilized to determine whether or not to initiate autonomous operations in some examples.

At 416, the method 400 includes a determination as to whether or not a command has been received from an external memory controller. If not, the method 400 proceeds to determine if a first timing threshold has been reached at 418. If the first timing threshold has been reached at 418, the method 400 autonomously enters a self refresh (SR) mode at 420. In the self-refresh mode, the memory manager implementing the method 400 autonomously refreshes all or a portion of memory media storage without an explicit refresh command received from an external memory controller. After the refresh command, the method 400 increments a counter at 428 and returns to the determination at 416 to check if an explicit command has been received at an input of the device from the external memory controller. Upon determining at 418 that first threshold has not been reached, the method proceeds to 424. At 424, if a second timing threshold has been reached, the method executes a local (e.g., inside memory device) precharge command and proceeds to increment the counter at 428 and proceeds back to 416 to check if an explicit command has been received at an input of the device from the external memory controller.

If a command has been received from an external memory controller at 416, the method proceeds to 432. In response to the command received at 416, the memory manager can decode the command (e.g., by command decoder 250) and decode an address for the data identified in the command (e.g., by address decoder 270). At 432, the method 400 determines whether or not to exit self refresh mode initiated at 420. If so, the method 400 exits self fresh mode at 433 and proceeds to 434. If at 432, the method determines that it is not in self refresh mode, the method 400 proceeds to 434. At 434, the method 400 determines whether or not the command detected and decoded at 416 requires an open page. Examples of commands requiring already open pages can include a read command, a write command or an explicit precharge command. If the command does not require an open page, the method 400 proceeds to 440, executes the explicit command received from the external memory controller and resets counters. If a page is required to be opened at 434, the method 400 proceeds to 444 to determine whether or not any page is currently open. If no page is currently open at 444, the method 400 proceeds to 450 and executes a local activate command to load the page into the local memory buffer (e.g., buffer 130 or 230) according to the decoded address for the data identified in the command. From 450, the method proceeds to 440 to execute the command (e.g., read or write data to the memory media storage) and reset counters.

If a page is currently open at 444, the method 400 proceeds to 454 to determine whether or not the requested page is open. If the requested page is open at 454, the method proceeds to 440 and executes the requested command. In response to determining (e.g., based on the decoded address) that a different page from that requested is open at 454, the method 400 proceeds to 460 and executes an autonomous local precharge command to close the currently active, non-requested page. From 460, the method proceeds to 450 to execute an autonomous activate command to buffer the requested page. From 450, the method proceeds to 440 to execute the command received at 416 based on the data that has been loaded into the buffer via the local activate at 450. As noted previously, the method 400 can provide an output to the external controller to notify the controller that the non-requested page has been precharged and the requested page has been opened to comply with the memory protocol implemented by the memory controller (or other external device) that issued the command.

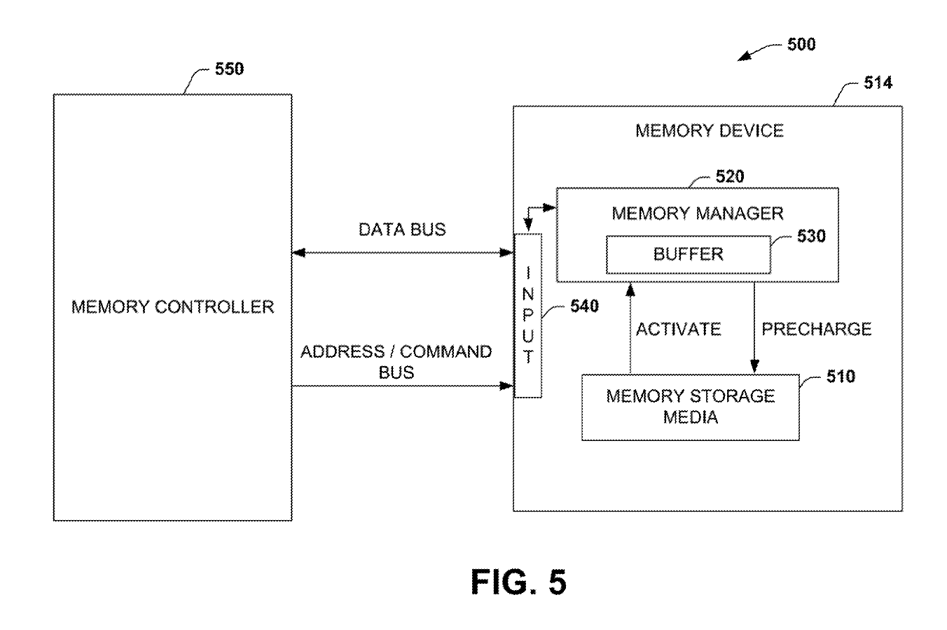

FIG. 5 illustrates an example of a system 500 to provide autonomous operations from an external memory controller that includes autonomously managing pages that are different from the pages requested by the memory controller. The system 500 includes a memory storage media 510 to store data for a memory device 514. A memory manager 520 autonomously manages paging operations for a buffer 530. The autonomous paging operations include initiating an autonomous precharge of a buffered page from the buffer 530 into the memory storage media 510 in the absence of detecting a command at an input 540 of the memory device 514 for a period of time that exceeds a threshold. The memory manager 520 also initiates an autonomous precharge of the buffered page from the buffer 530 into the memory storage media 510 if the detected command specifies a requested memory page from the memory storage media that is not the buffered page.

A memory controller 550 generates the command at the input of the memory device 514. As noted previously with respect to FIG. 2, the memory manager 520 can include a command decoder to receive the command at the input of the memory device and an address decoder to determine a requested page in the memory storage media. The command decoder notifies the memory manager of the command to execute and the address decoder specifies which memory page the command is to be executed. The memory manager 520 autonomously activates the requested memory page into the buffer 530 in response to determining that the requested page is not open and then executes the decoded command with respect to the requested memory page that is activated into the buffer.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A memory device comprising:
a memory storage media to store data for the memory device; and
a memory manager to initiate an autonomous precharge of a buffered page into the memory storage media in the absence of detecting a command at an input of the memory device for a period of time that exceeds a threshold.

2. The memory device of claim 1, the memory manager further comprising a timing circuit to increment a counter to measure the period of time from a last command detected at the input and determine whether the period of time exceeds the threshold,
wherein if the counter exceeds a predetermined count threshold before a next command is detected at the input of the memory device, the memory manager initiates the autonomous precharge of the buffered page into the memory storage media.

3. The memory device of claim 1, further comprising:
a command decoder to receive and process the command at the input of the memory device, the command decoder specifies a decoded command that the memory manager is requested to execute; and
an address decoder to determine an address for a requested page in the memory storage media in response to the command at the input of the memory device, the address decoder specifies the address for the requested page for which the memory manager is to execute the decoded command,
wherein the memory manager is to perform an autonomous paging operation with respect to a buffer and/or the memory storage media based on the decoded command and the specified address.

4. The memory device of claim 3, wherein the memory manager executes the autonomous precharge of the buffered page into the memory storage media in response to determining that the specified address is different from an address of the buffered page that is currently active in the buffer.

5. The memory device of claim 4, wherein, after completing the autonomous precharge, the memory manager executes an autonomous activate command to activate a different page from the memory storage media into the buffer based on the specified address.

6. The memory device of claim 3, wherein the memory manager executes an autonomous activate command in response to detecting a command requesting data from a page of the memory storage media that has previously been precharged via an autonomous precharge command.

7. The memory device of claim 3, wherein the memory manager executes an autonomous activate in response to determining that no page of data is currently active in the buffer.

8. The memory device of claim 3, the memory manager further comprising an output to generate a response indicating that a page of memory has been stored, activated, or precharged.

9. The memory device of claim 1, the memory manager executes a refresh command to the memory storage media to refresh areas of memory that have been autonomously precharged.

10. The memory device of claim 1, the memory storage media includes a dynamic random access memory, a resistive random access memory, a phase change memory, or a spin transfer torque memory.

11. A method comprising:
determining if a requested memory page from a memory storage media is open;
autonomously precharging another memory page from a buffer into the memory storage media if the requested memory page from the memory storage media is not open; and
autonomously activating the requested memory page into the buffer from the memory storage media after the precharging if the requested memory page is not open.

12. The method of claim 11, further comprising autonomous precharging a currently buffered page into the memory storage media in the absence of detecting a command at an input of a memory device for a period of time that exceeds a threshold.

13. The method of claim 12, wherein the threshold is a precharge threshold, the method further comprising executing an autonomous refresh command with respect to the memory storage media in response to the period of time exceeding another threshold that is different from the precharge threshold.

14. A system, comprising:
a memory storage media to store data for a memory device;
a memory manager to autonomously manage paging operations for a buffer, the paging operations including:
to initiate an autonomous precharge a buffered page from the buffer into the memory storage media in the absence of detecting a command at an input of the memory device for a period of time that exceeds a threshold, and
to initiate another autonomous precharge of the buffered page from the buffer into the memory storage media if the detected command specifies a memory page requested from the memory storage media that is not the buffered page; and
a memory controller to generate the command at the input of the memory device.

15. The system of claim 14, the memory manager further comprises:
a command decoder to receive the command at the input of the memory device and determine a decoded command;
an address decoder to determine an address for a requested page in the memory storage media based on the command at the input of the memory device,
the command decoder notifies the memory manager of the command to execute and the address decoder specifies the address for the requested page for which the decoded command is to be executed, and
the memory manager to autonomously activate the requested page into the buffer in response to determining that the requested page is not open and then execute the decoded command with respect to the requested page that is activated into the buffer.
